(19) United States
(12) Patent Application Publication
(10) Pub. No.: US 2026/0170762 A1
(43) Pub. Date: Jun. 18, 2026

(54) SYSTEMS AND METHODS FOR GENERATING CONFEDERATED AS-BUILT MODELS OF PROPERTIES

(71) Applicant: Tailorbird Inc., Princeton, NJ (US)

(72) Inventors: Michael Timothy Cantwell, Princeton, NJ (US); Ashish Jain, Princeton, NJ (US); Shayegan Shakeri, Princeton, NJ (US); Manthan Marvaniya, Princeton, NJ (US); Jenit Shah, Princeton, NJ (US); Nicolas Abosky, Princeton, NJ (US); Jaime Moreno, Princeton, NJ (US); Natali Caffaratti, Princeton, NJ (US); Camila Sarasin, Princeton, NJ (US); Maria Celeste Chiani, Princeton, NJ (US)

(21) Appl. No.: 19/417,964

(22) Filed: Dec. 12, 2025

Related U.S. Application Data
(60) Provisional application No. 63/733,400, filed on Dec. 12, 2024.

(51) Int. Cl. G06T 17/20; G06N 3/0464

(52) U.S. Cl. CPC G06T 17/20; G06N 3/0464

(57) ABSTRACT

The invention is directed to systems and methods for reality mapping and generating a three-dimensional (3D) model of a property (i.e., building or the like), including rendering of as-built conditions of interior and exterior portions of the building based on pre-existing, publicly available data.

### TECHNICAL FIELD

The disclosure relates generally to computer-generated models, and, more specifically to, systems and methods for reality mapping and generating a three-dimensional (3D) model of a property (i.e., building or the like), including rendering of as-built conditions of interior and exterior portions of the building based on pre-existing, publicly available data.

### BACKGROUND

Currently available as-built reality mapping techniques in the real estate and construction industries can be extremely expensive. In particular, current techniques generally rely on high-accuracy scanning instruments with geo-referencing capabilities (e.g., LIDAR laser scanners), which further present logistic difficulties, in that the data must be collected in the field, which requires one or more trips to be planned to so as to be physically present at a given property.

While there have been advancements in developing mechanisms to convert 3D scans into 3D building information models, existing methods generate one 3D model for each scan (i.e., an exterior/shell of the building gets scanned separately, while interior portions of the building require a separate scan). As such, there are currently no methods of tying these two models together to generate a single, confederated model without requiring sophisticated geo-referencing methods using on-site survey control points during data capture.

### SUMMARY

The present invention recognizes the drawbacks of current reality mapping techniques by providing a system that automates the extraction and integration of pre-existing, publicly available data to generate detailed 3D models of properties. The system uses a series of unique techniques to analyze and synthesize data from different data sources and subsequently render a single confederated model of a building, including rendering of as-built conditions of interior and exterior portions of the building.

As previously discussed, when managing real estate buildings or structures, on-site data collection involved in order to obtain information about the property (i.e., information associated with the interior and/or aspects) is time consuming and expensive.

The system of the present invention provides a uniquely efficient means of generating 3D models for management of real estate properties. The system combines the data from public databases, processes said data to determine the structure and characteristics of the properties, and generates a confederated 3D model based on this data without the need for any on-site manual collection of the data. As such, the system of the present invention essentially eliminates the need for on-site data collection, thereby providing a more cost-efficient means of managing a given property.

The 3D models generated by the system of the present invention are effectively digital twins of the real estate property asset (also referred to herein as a “building”), containing structured measurable building units with metadata, following a specific data schema that may comply with Master Data Models (MDMs) that can be used to generate budget documents, or other consumer-facing applications (property assessment tools). The system includes multiple computer vision (CV) modules for processing data in a highly sophisticated and unique manner, wherein such CV modules are sequenced to first parallelly generate an interior space for each floorplan layout, and an up-to-scale single 3D model for the exterior of the building. In effect, the system analyzes the spatial optimization problem to merge two models (i.e., fit one or more interior models into the exterior model) to thereby create a confederated model providing an accurate depiction of real conditions of the given building.

The system of the present invention has applications in urban planning and management of real estate properties. The 3D models generated from the system provide accurate representation of the building, which enables virtual representative tours and enables more accurate decisions about the building. In addition, the 3D models generated from the system accurately represent building elements in detail. Specifically, incorporating the metadata from disparate sources is invaluable for budgeting estimates. Thus, the 3D models generated by the system allow convenient and graphic representation of the commercial information pertaining to the building.

The invention further recognizes that the systems provided in the invention are applicable to 3D model generation of any structure. Specifically, the systems of the invention may be utilized for generation of 3D models of multifamily housing, single family housing, condominiums, apartments, and/or townhouses. The systems of the invention may also be utilized for generating 3D models of commercial buildings, such as malls, shopping complexes, multilevel parking lots, hospitals, airports (including various structures in the airport, such as airport terminals, parking ramps, baggage storage buildings, and cargo handling facilities), and/or stadiums. In certain other aspects, the systems of the invention may be utilized to generate accurate 3D models of government buildings, including the municipal complexes, schools, and/or buildings pertaining to the utility services.

For example, in one aspect, the invention provides a system for generating a 3D model of a building (or any other type of property), wherein the system includes a server configured to communicate and exchange data with one or more computing devices over a network. The server is configured to retrieve and process publicly available data to generate a 3D model of the building, including rendering of as-built conditions of interior and exterior portions of the building. The building may include, but it not limited to residential or commercial properties, such as a single-family home, a multifamily home, an apartment dwelling, a hotel, a retail outlet, a mall, student housing, and schools, to name a few.

As an initial step, the server is configured to retrieve, via a data retrieval module, data from databases associated with the building, including retrieving at least a first set of data and a second set of data. In certain embodiments, the databases associated with the building from which the information is retrieved are publicly available databases. For example, the publicly available databases are available on the world wide web (i.e., the Internet). These databases may be selected from any available databases comprising information about real estate properties. For example, such databases include websites such as Zillow or Redfin. In certain embodiments, the publicly available databases could be any additional publicly available government databases including the records about a real estate property.

In certain embodiments, the retrieving step comprises collecting data from at least three different public databases, wherein the public databases comprise information related to said building, including, information associated with geographical, structural, and/or aesthetic details of the building. Such information may include the GPS coordinates of the said building. The information may further include information regarding the geographical terrain of the site of the building. The information may further include structural aspects of the building, such as the size of the building, occupancy limit, the area of the building, the floor area of the building.

For example, the first set of data may include information associated with the exterior portion of the building (i.e., aerial images of the building), while the second set of data may include information associated with an interior of the building (i.e., floorplans and/or images of interior space of the building).

Upon retrieving the first and second sets of data, the server is then configured to generate a two-dimensional (2D) building floor outline of each floor of the building (based on processing of the first set of data) and 2D vector model of an interior layout of each floor of the building (based on processing of the second set of data) via respective exterior and interior model generation modules.

The exterior model generation module is configured to generate a 2D building floor outline corresponding to an exterior perimeter of one or more floors the building based, at least in part, on processing the first set of retrieved data and determine, based on the processing, exterior dimensions and/or characteristics building.

As previously noted, the first set of data may include aerial images of the building and the exterior model generation module may be configured generate at least one of a 3D point cloud model and a 3D mesh model from the aerial images. For example, the exterior model generation module may process the aerial images by running one or more convolutional neural network (CNN) models and/or one or more plane fitting algorithms to generate a 3D shell model from the 3D point cloud model and/or the 3D mesh model. The 3D shell model may generally include a plurality of exterior features associated with the exterior of the building, including, but not limited to, walls, roofs, and/or other exterior elements associated with the building. The 3D shell model may also include one or more different floors of the building.

The interior model generation module is configured to generate a 2D vector model of an interior layout of each floor of the building based, at least in part, on processing the second set of retrieved data and determine, based on the processing, a floor plan layout for each floor of the building. For example, in some embodiments, the interior model generation module is configured to perform, via a web scraper, web data extraction, which includes automatically searching for, and extracting, unit interior data from public websites associated with one or more floorplans and/or images of interior space of the building. The server is configured to store the unit interior data, along with relevant metadata associated therewith, in an associated database. The interior model module processes the unit interior data by running one or more convolutional neural network (CNN) models for detecting visible interior elements associated with at least one of the one or more floorplans. The visible interior elements may generally be associated with walls, doors, windows, and/or other internal fixtures.

Finally, the server is configured to compile, via a merging module, the 2D building floor outline and a 2D vector model generated for each floor of the building to thereby generate a 3D model of the building. Effectively, the merging module fills in each 2D building floor outline with known number of 2D vector models of each floorplan. The floorplan may get ununiformed transformation during optimization. In the event the building is a residential building, the ununiformed transformation during optimization happens by the non-kitchen-and-bath walls moved if needed.

In certain embodiments, the merging module runs a genetic algorithm to fill in the 2D building floor outline with one or more known 2D vector models of a given floorplan type functioning as a dwelling building unit. In certain embodiments, the merging module is configured to implement an optimization model. In certain embodiments, the merging module is configured to optimize a dwelling building unit by implementing one or more loss functions, wherein the loss functions are selected from the group consisting of: minimizing empty space in the 2D vector model to account for corridors; minimizing a number of adjustments each floorplan type will have during optimization; and maximizing an amount of overlap each floorplan type will have within an outline of a given floorplan of the 2D vector model. In certain embodiments, the optimization step further comprises defining one or more constraints in the optimization model. In certain embodiments, the one or more constraints comprise matching placement of one or more interior elements of the 2D vector model with corresponding one or more exterior elements of the 2D building floor outline.

In some embodiments, the system may further include a spatial analysis module configured to process one or more images of interior space of the building to determine dimensions, including heights, of interior elements of the building based on processing of the one or more images. In certain embodiments, the spatial analysis module is configured to adjust the 2D vector model based on the determined dimensions of the interior elements, thereby resulting in generation of the 3D model of the building providing an accurate scale of interior elements.

In certain embodiments, the server is further configured to annotate the 3D model with the details associated with interior elements of the building. The details may include, for example, the number of furnishings, fixtures, and equipment for a given model. In certain embodiments, the furnishings and fixtures are selected from the group consisting of: cabinet box sets, cabinet fronts, number of light switches, light fixtures, bathroom amenities, and ceiling fans.

### BRIEF DESCRIPTION OF THE DRAWINGS

Features and advantages of the claimed subject matter will be apparent from the following detailed description of embodiments consistent therewith, which description should be considered with reference to the accompanying drawings.

FIG. 1 is a block diagram illustrating one embodiment of an exemplary system for generating a 3D model of a building consistent with the present disclosure.

FIG. 2 is a block diagram illustrating the system in greater detail.

FIG. 3 is a block diagram illustrating various components of the system.

FIG. 4 is a flow diagram illustrating the processing of data, via the exterior model generation module, for the generation of a 2D building floor outline corresponding to an exterior perimeter of one or more floors the building.

FIG. 5 is a flow diagram illustrating the processing of data, via the interior model generation module, for the generation of a 2D vector model of an interior layout of each floor of the building.

FIG. 6 is a flow diagram illustrating the process of compiling, via the merging module, the 2D building floor outline and a 2D vector model generated for each floorplan of the building to thereby generate a 3D model of the building.

FIG. 7 is an exemplary image of aerial image API.

FIG. 8 is a screenshot of an exemplary aerial imagery API interface.

FIG. 9 is a screenshot aerial image API with a cropped building in the aerial image.

FIG. 10A and FIG. 10B are screenshots of the point cloud partial segmentation of the image.

FIG. 11 is a screenshot of the interface for vector floorplans.

FIG. 12 is a screenshot for floorplan transformation interface.

FIG. 13 is screenshot of an example of the vectorized output of the generated floorplan overlaid on the input image of the floorplan.

FIG. 14 is a cropped 3D point cloud of building's exterior generated from the aerial images.

FIG. 15 is a screenshot of the 3D shell of the roof and walls of the building.

FIG. 16 is a screenshot of the 3D shell overlaid with the 3D point cloud.

FIG. 17 is a screenshot of the 3D shell (output) overlaid on the uncropped 3D point cloud from the aerial image.

FIG. 18 is a screenshot of the roof creation tool from the generated aerial images.

FIG. 19 is an example of a building floor outline extracted from the 3D building shell.

FIG. 20 is an example of final output of merging module for each floor of the building.

FIG. 21A and FIG. 21B are examples of 2D floorplan vector models of each subunit in the building.

FIG. 22 provides an example of the 3D model of the building generated by the merging module of the system.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient.

### DETAILED DESCRIPTION

The system of the present invention provides a uniquely efficient means of generating 3D models for management of real estate properties. The system combines the data from public databases, processes said data to determine the structure and characteristics of the properties, and generates a confederated 3D model based on this data without the need for any on-site manual collection of the data. As such, the system of the present invention essentially eliminates the need for on-site data collection, thereby providing a more cost-efficient means of managing a given property.

The 3D models generated by the system of the present invention are effectively digital twins of the real estate property asset (also referred to herein as a “building”), containing structured measurable building units with metadata, following a specific data schema that may comply with Master Data Models (MDMs) that can be used to generate budget documents, or other consumer-facing applications (property assessment tools). The system includes multiple computer vision (CV) modules for processing data in a highly sophisticated and unique manner, wherein such CV modules are sequenced to first parallelly generate an interior space for each floorplan layout, and an up-to-scale single 3D model for the exterior of the building. In effect, the system analyzes the spatial optimization problem to merge two models (i.e., fit one or more interior models into the exterior model) to thereby create a confederated model providing an accurate depiction of real conditions of the given building.

The system of the present invention has applications in urban planning and management of real estate properties. The 3D models generated from the system provide accurate representation of the building, which enables virtual representative tours and enables more accurate decisions about the building.

The invention further recognizes that the systems provided in the invention are applicable to 3D model generation of any structure. Specifically, the systems of the invention may be utilized for generation of 3D models of multifamily housing, single family housing, condominiums, apartments, and/or townhouses. The systems of the invention may also be utilized for generating 3D models of commercial buildings, such as malls, shopping complexes, multilevel parking lots, hospitals, airports (including various structures in the airport, such as airport terminals, parking ramps, baggage storage buildings, and cargo handling facilities), and/or stadiums. In certain other aspects, the systems of the invention may be utilized to generate accurate 3D models of government buildings, including the municipal complexes, schools, and/or buildings pertaining to the utility services.

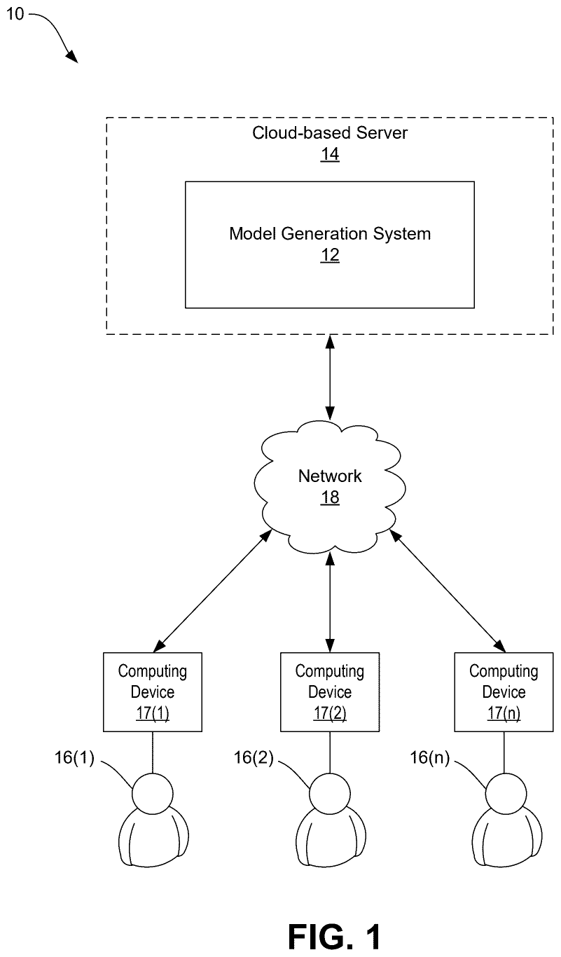

FIG. 1 is a block diagram illustrating one embodiment of an exemplary system 10 for generating a 3D model of a building consistent with the present disclosure. As shown, system includes a model generation system or platform 12 embodied on an internet-based computing system/service. For example, as shown, the model generation system 12 may be embodied on a cloud-based server 14, for example. The model generation system 12 is configured to communicate and share data, specifically property data including 3D models of a property of interest, with one or more users 16(1)-16(n) via user computing devices 17(1)-17(n) over a network 18. In the present context, the users may generally be subscribers to the property mapping and modeling services provided by the system 12.

The network 18 may be any network that carries data. Non-limiting examples of suitable networks that may be used as network 18 include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, Bluetooth radio, Near Field Communication (NFC), the most recently published versions of IEEE 802.11 transmission protocol standards as of October 2024, other networks capable of carrying data, and combinations thereof. In some embodiments, network 18 is chosen from the internet, at least one wireless network, at least one cellular telephone network, and combinations thereof. As such, the network 18 may include any number of additional devices, such as additional computers, routers, and switches, to facilitate communications. In some embodiments, the network 18 may be or include a single network, and in other embodiments the network 18 may be or include a collection of networks.

The network 18 may represent, for example, a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between any of the computing devices 17, the system 12, and the cloud-based server 14, may be, in whole or in part, a wired connection.

The model generation system 12 is configured to communicate and share data with the computing devices 17 associated with one or more users 16. Accordingly, the computing device 17 may be embodied as any type of device for communicating with the model generation system 12 and cloud-based server 14, and/or other user devices over the network 18. For example, at least one of the user devices may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing device configured to store and access data, and/or to execute software and related applications consistent with the present disclosure. In the embodiments described here, the computing device 17 is generally embodied as a PC. However, it should be noted that one or more devices 17 may include a smartphone or tablet, and the like.

As will be described in greater detail herein, the model generation system 12 provides an interface with which a user 16 may interact via an associated computing device 17, wherein the system 12 provides property mapping and modeling services, including the generation of 3D models of a property of interest. The system 12 may be deployed via a digital cloud, allowing for users to easily access the platform and obtain detailed models of a property of interest. The system 12 has applications in urban planning and management of real estate properties. The 3D models generated from the system provide accurate representation of the building, which enables virtual representative tours and enables more accurate decisions about the building.

It should be noted that embodiments of the system 10 of the present disclosure include computer systems, computer operated methods, computer products, systems including computer-readable memory, systems including a processor and a tangible, non-transitory memory configured to communicate with the processor, the tangible, non-transitory memory having stored instructions that, in response to execution by the processor, cause the system to perform steps in accordance with the disclosed principles, systems including non-transitory computer-readable storage medium configured to store instructions that when executed cause a processor to follow a process in accordance with the disclosed principles, etc.

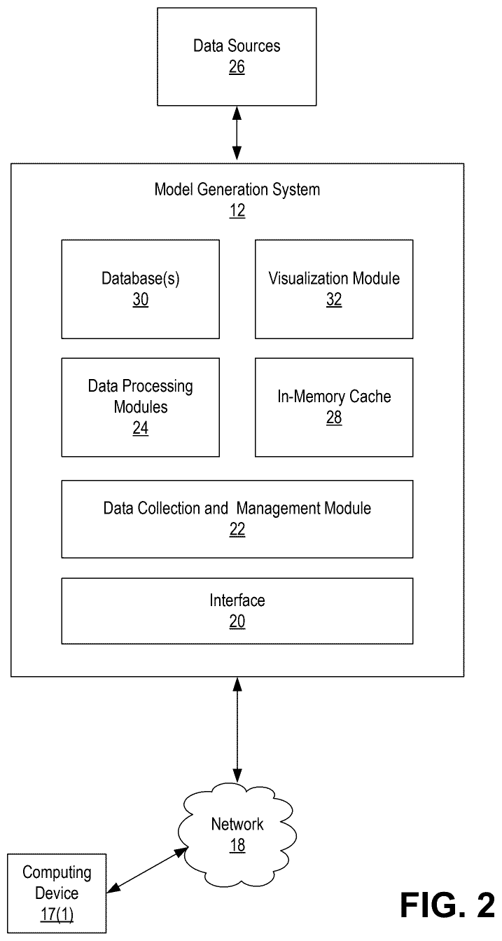

FIG. 2 is a block diagram illustrating the model generation system 12 in greater detail. As shown, the model generation system 12 includes an interface 20, a data collection and management module 22, various data processing modules 24, in-memory cache 28, and various databases 30 for storage of data, and a visualization module 32.

The interface 20 may generally allow a user to access data on the model generation system 12, via a software application, for example, provided on the computing device (i.e., via a mobile software application accessible via a mobile device) or via a web-based portal. For example, upon accessing a software application, the interface 20 may be presented to the user via their device 17, in which the user may navigate a dashboard or standard platform interface so as to select a specific property (i.e., building or the like) of which a 3D model is to be rendered. Upon selecting a specific property of interest, system 12 is configured to provide a visual rendering, via the visualization module 32, of a 3D model of the property of interest, as described in greater detail herein.

The data collection and management module 22 is configured to receive session data (i.e., input from the user during a given session, including user selection data), at which point the data processing modules 24 are configured to retrieve and process data for the subsequent rendering of a 3D model to be visually presented to the user (via the visualization module 32) by way of the interface of the platform. For example, in response to session data (including user selection input with the interface), one or more of the data processing modules 24 are configured retrieve and analyze/process data sets from remote, third-party data sources 26 (specifically publicly available data sources) to render a 3D model of the property of interest. The one or more data processing modules 24 may utilize the in-memory cache 28 and databases 30 during processing steps.

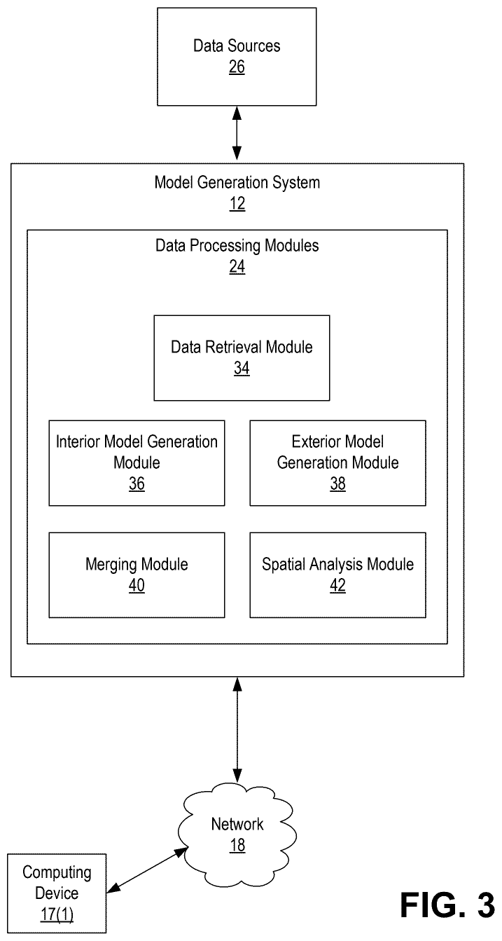

FIG. 3 is a block diagram illustrating the various data processing modules 24 of the system 12. As shown, the system may include a data retrieval module 34, an interior model generation module 36, an exterior model generation module 38, a merging module 40, and optionally a spatial analysis module 42.

The data retrieval module 34 is configured to retrieve data from the data sources 26. For example, as an initial step, the data retrieval module 34 is configured to retrieve data from publicly available databases, such as databases are available on the world wide web (i.e., the Internet). These databases may be selected from any available databases comprising information about real estate properties. For example, such databases include websites such as Zillow or Redfin. In certain embodiments, the publicly available databases could be any additional publicly available government databases including the records about a real estate property.

In certain embodiments, the retrieving step comprises collecting data from at least three different public databases, wherein the public databases comprise information related to said building, including, information associated with geographical, structural, and/or aesthetic details of the building. Such information may include the GPS coordinates of the said building. The information may further include information regarding the geographical terrain of the site of the building. The information may further include structural aspects of the building, such as the size of the building, occupancy limit, the area of the building, the floor area of the building.

For example, in response to a user selecting a building of interest, the data retrieval module 34 may be configured to retrieve at least a first set of data, which may include information associated with an exterior portion of the building (i.e., aerial images of the building), and a second set of data, which may include information associated with an interior of the building (i.e., floorplans and/or images of interior space of the building).

The interior model generation module 36 is configured to generate a 2D vector model of an interior layout of each floor of the building based, at least in part, on processing the second set of retrieved data and determining, based on the processing, a floor plan layout for each floor of the building.

The exterior model generation module 38 is configured to generate a 2D building floor outline corresponding to an exterior perimeter of one or more floors the building based, at least in part, on processing the first set of retrieved data and determining, based on the processing, exterior dimensions and/or characteristics building.

The merging module 40 is configured to compile the 2D building floor outline and the 2D vector model generated for each floor of the building to thereby generate a 3D model of the building. Effectively, the merging module fills in each 2D building floor outline with known number of 2D vector models of each floorplan. The floorplan may get ununiformed transformation during optimization. In the event the building is a residential building, the ununiformed transformation during optimization happens by the non-kitchen-and-bath walls moved if needed.

The spatial analysis module 42 is configured to process one or more images of interior space of the building to determine dimensions, including heights, of interior elements of the building based on processing of the one or more images. The spatial analysis module 42 may be configured to adjust the 2D vector model based on the determined dimensions of the interior elements, thereby resulting in generation of the 3D model of the building providing an accurate scale of interior elements.

### Exterior Model Generation Module

As previously described herein, the exterior model generation module is configured to generate a 2D building floor outline corresponding to an exterior perimeter of one or more floors the building based, at least in part, on processing the first set of retrieved data and determining, based on the processing, exterior dimensions and/or characteristics building.

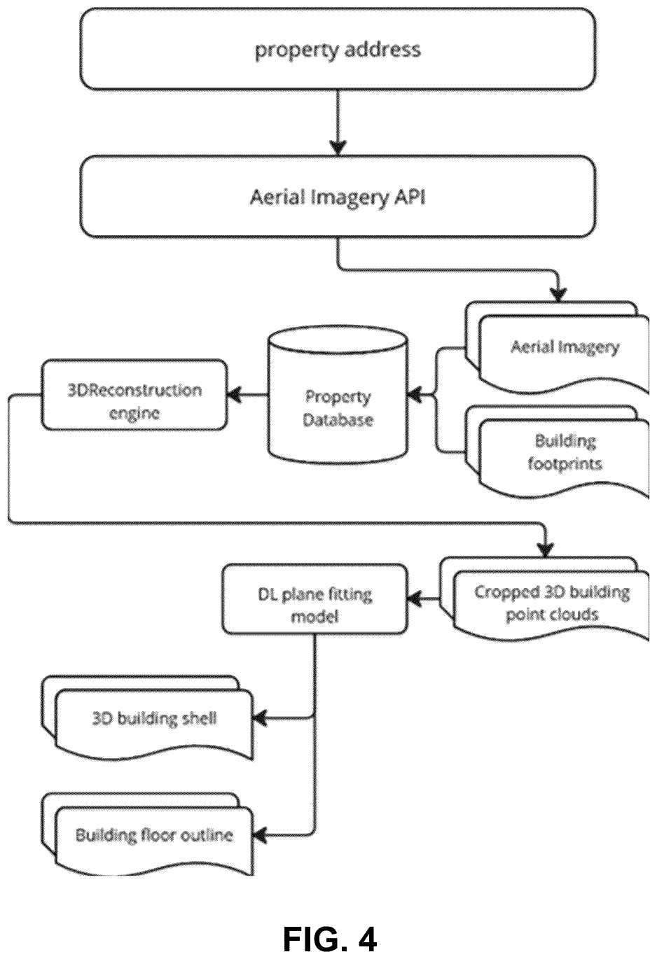

FIG. 4 is a flow diagram illustrating the processing of data via the exterior model generation module. As shown, the exterior model generation module utilizes the property address or any other identifying parameters and obtain any images related to the exterior of the property. In certain embodiments, the photographs are aerial photographs.

The exterior model generation module generates a 2D building floor outline corresponding to an exterior perimeter of one or more floors the building. In particular, the exterior model generation module models the exterior of the building. The first step in generation of the models of the invention is the generation of an exterior model. In certain aspects, a 3D point cloud gets generated from existing aerial images containing the property address using photogrammetry. Deep Learning based segmentation and plane fitting techniques are utilized by the systems of the invention to generate a 3D building shell model that consists of roofs and walls (including openings: doors and windows). This shell can be split into different floors. At this step, each floor has a building floor outline.

In certain embodiments, the invention further provides that the exterior model generation module is configured to generate at least one of a 3D point cloud model and a 3D mesh model from these aerial images. In certain embodiments, the invention further provides that the exterior model generation module is configured to generate a 3D point cloud model and a 3D mesh model from these aerial images. In certain embodiments, exterior model generation module processes the aerial images by running one or more convolutional neural network (CNN) models and/or one or more plane fitting algorithms to generate the 3D shell model from the 3D point cloud model and/or the 3D mesh model. In certain embodiments, the 3D shell model comprises a plurality of exterior features associated with the exterior of the building. In certain embodiments, the plurality of exterior features comprise one or more walls, roofs, and/or other exterior elements associated with the building. In certain embodiments, the 3D shell model comprises one or more different floors of the building.

### Interior Model Generation Module

The interior model generation module is configured to generate a 2D vector model of an interior layout of each floor of the building based, at least in part, on processing the second set of retrieved data and determining, based on the processing, a floor plan layout for each floor of the building.

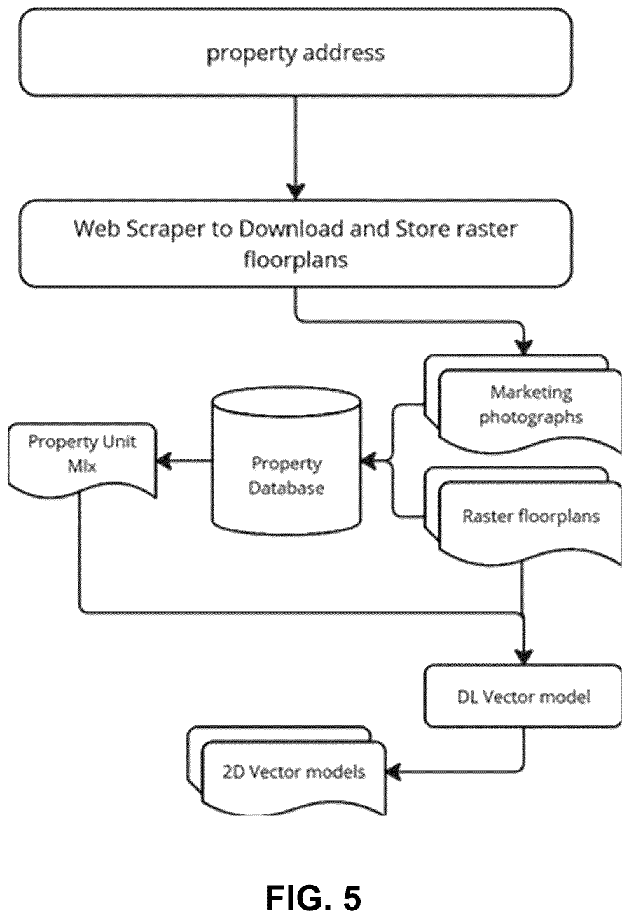

FIG. 5 is a flow diagram illustrating the processing of data via the interior model generation module. In certain embodiments, the interior model generation module is configured to perform, via a web scraper, web data extraction. Specifically, the web scraper will download all available data pertaining to the floorplans of the building and/or real estate asset. The web-scraper may download the information based on the address of the property. The data downloaded by the web scraper may include floorplan raster images plus other marketing photographs of interior spaces. The downloaded data is stored with proper metadata in the system.

In exemplary embodiments, the system starts with providing the property address to the system. The web scraper downloads and stores the floorplans. The data downloaded by the web scraper include, but not limited to, marketing photographs, raster floorplans, or any other publicly available information regarding the internal structure of the real estate property. The information is stored in a property database and subsequently processed through a DL vector model.

In certain embodiments, the web data extraction comprises automatically searching for, and extracting, unit interior data from public websites associated with one or more floorplans and/or images of interior space of the building. In certain embodiments, the server is configured to store the unit interior data, along with relevant metadata associated therewith, in an associated database. In certain embodiments, the interior model module processes the unit interior data by running one or more convolutional neural network (CNN) models for detecting visible interior elements associated with at least one of the one or more floorplans. In certain embodiments, the visible interior elements are associated with walls, doors, windows, and/or other internal fixtures.

### Merging Module

The merging module compiles the 2D building floor outline and a 2D vector model generated for each floor of the building to thereby generate a 3D model of the building. Effectively, the merging module fills in each 2D building floor outline with known number of 2D vector models of each floorplan. The floorplan may get ununiformed transformation during optimization. In the event the building is a residential building, the ununiformed transformation during optimization happens by the non-kitchen-and-bath walls moved if needed.

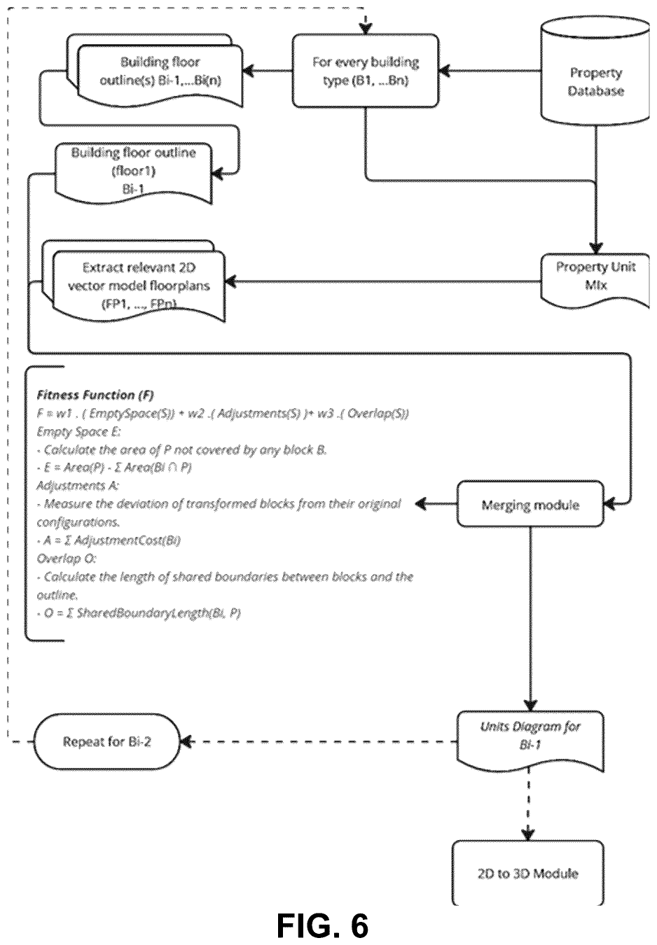

FIG. 6 is a flow diagram illustrating the process of compiling, via the merging module, the 2D building floor outline and a 2D vector model generated for each floor of the building to thereby generate a 3D model of the building.

In certain embodiments, the merging module runs a genetic algorithm to fill in the 2D building floor outline with one or more known 2D vector models of a given floorplan type functioning as a dwelling building unit. In certain embodiments, the genetic algorithm relies on chromosome representation. The functioning of the chromosome representation are provided below:

Genes: Each gene in a chromosome represents a specific floorplan block and its position and orientation within the building outline.
Encoding: A chromosome might be encoded as a vector of tuples, where each tuple includes:
Block ID
X and Y coordinates
Orientation angle
Transformation parameters (e.g., wall adjustments).

In certain embodiments, the merging module is configured to implement an optimization model. More specifically, the merging module may be configured to optimize a dwelling building unit by implementing one or more loss functions, wherein the loss functions are selected from the group consisting of: minimizing empty space in the 2D vector model to account for corridors; minimizing number of adjustments each floorplan type will have during optimization; and maximizing an amount of overlap each floorplan type will have within an outline of a given floorplan of the 2D vector model.

In certain embodiments, the fitness function (F) can be mathematically expressed as:

$$F = w 1 \cdot ( EmptySpace ( S ) ) + w 2 \cdot ( Adjustments ( S ) ) + w 3 \cdot ( Overlap ( S ) )$$

In certain embodiments, the minimizing empty space function comprises configurations that reduce unused space within the building outline. This function also optionally considered space for corridors. In certain embodiments, the minimizing number of adjustments function penalizes configurations that require significant transformations to the floorplan blocks, maintaining as much of the original layout as possible. In certain embodiments, the maximizing overlap function rewards configurations that maximize the alignment of block sides with the building outline, ensuring a better fit.

In certain embodiments, the optimization step further comprises defining one or more constraints in the optimization model. In certain embodiments, the one or more constraints comprise matching placement of one or more interior elements of the 2D vector model with corresponding one or more exterior elements of the 2D building floor outline. In certain embodiments, the constraints ensure that specific conditions are met, such as matching window placements between the exterior and interior models. In certain embodiments, the window matching function relied upon spatial correlation techniques to align windows in the interior models with those in the exterior shell.

In certain embodiments, the penalty functions incorporate penalties into the fitness function for solutions that violate constraints. In certain embodiments, the penalties could be the unmatched window placements. In certain embodiments, the system further comprises repair functions. The repair functions automatically adjusts solutions that violate constraints to bring them back into a feasible region.

In certain embodiments, the mathematical modeling functions are provided herein:

### Layout Representation:

2D Floor Outline: Represent the 2D building floor outline as a polygon P with vertices {(xi, yi)}.
Floorplan Blocks: Represent each floorplan block B as a set of vertices with transformations T.

### Loss Functions:

### Empty Space E:

Calculate the area of P not covered by any block B.

$$- E = Area ( P ) - Σ Area ( Bi ∩ P )$$

### Adjustments A:

Measure the deviation of transformed blocks from their original configurations.

$$‐ A = Σ AdjustmentCost ( B i )$$

### Overlap O:

Calculate the length of shared boundaries between blocks and the outline.

$$‐ O = Σ SharedBoundaryLength ( Bi , P )$$

### Spatial Analysis Module

In certain embodiments, the invention provides that the system further comprises a spatial analysis module configured to process one or more images of interior space of the building to determine dimensions, including heights, of interior elements of the building based on processing of the one or more images. In certain embodiments, the spatial analysis module is configured to adjust the 2D vector model based on the determined dimensions of the interior elements, thereby resulting in generation of the 3D model of the building providing an accurate scale of interior elements.

An example of the generation of a 3D representation of a real estate property is provided herein.

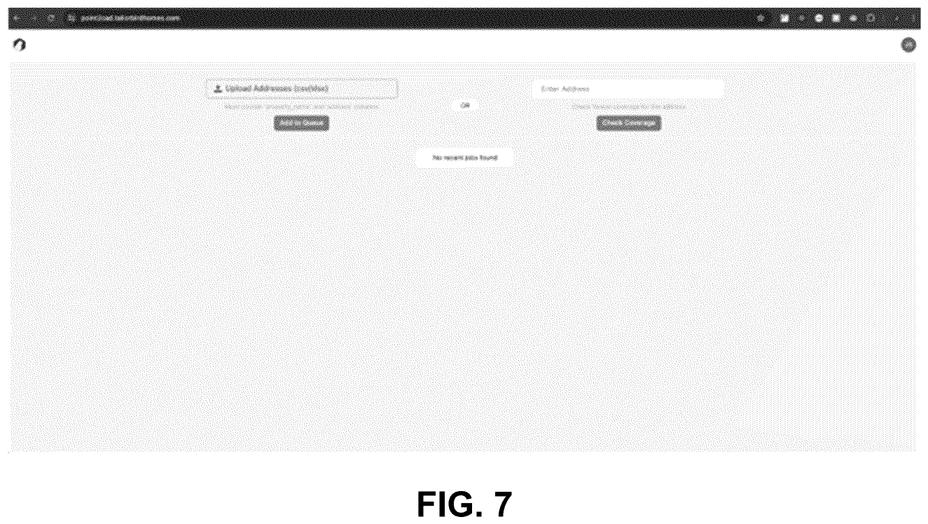

The first step in generation of a 3D representation of a real estate property starts by providing the address of the property. The address may be provided in the aerial image API. FIG. 7 provides an exemplary aerial image API.

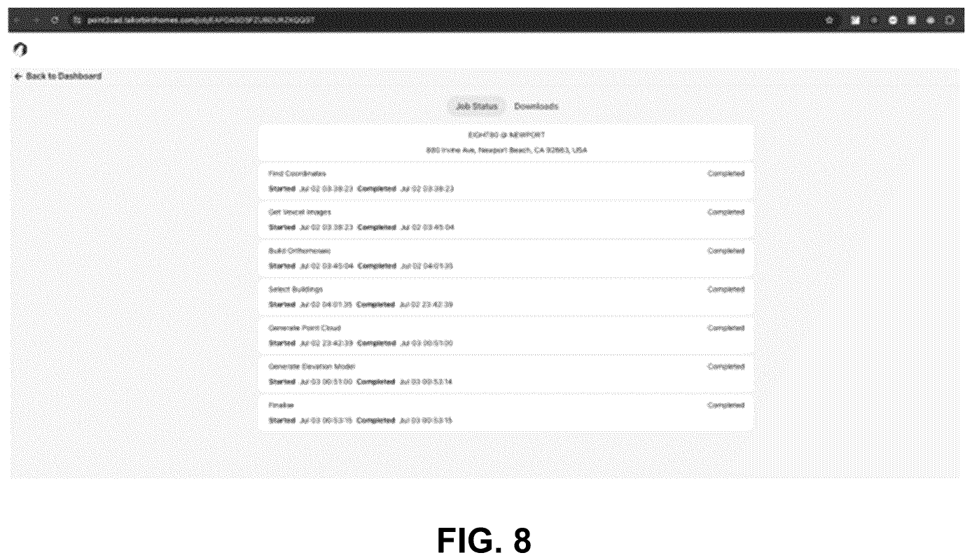

FIG. 8 provides an aerial image API interface displaying the status of the projects with the creation of the 3D models. In certain preferred embodiments, the aerial image is a high resolution image of the area of the interest. Subsequently, the obtained aerial images are aligned based on the camera positions. For example, the alignment may be different for satellite images and the images taken from a drone. The alignment provides a rough initial estimate of the camera positions, which is crucial for the subsequent steps.

In certain preferred embodiments, the systems of the invention further identifies the key points in the images to optimize the alignment. These key points are distinctive features that are matched across multiple images. The matching may be conducted by different set of images or in the same set of images. By identifying common key points, the alignment is further optimized to refine the camera positions and orientations. This process ensures that the images are accurately aligned with each other.

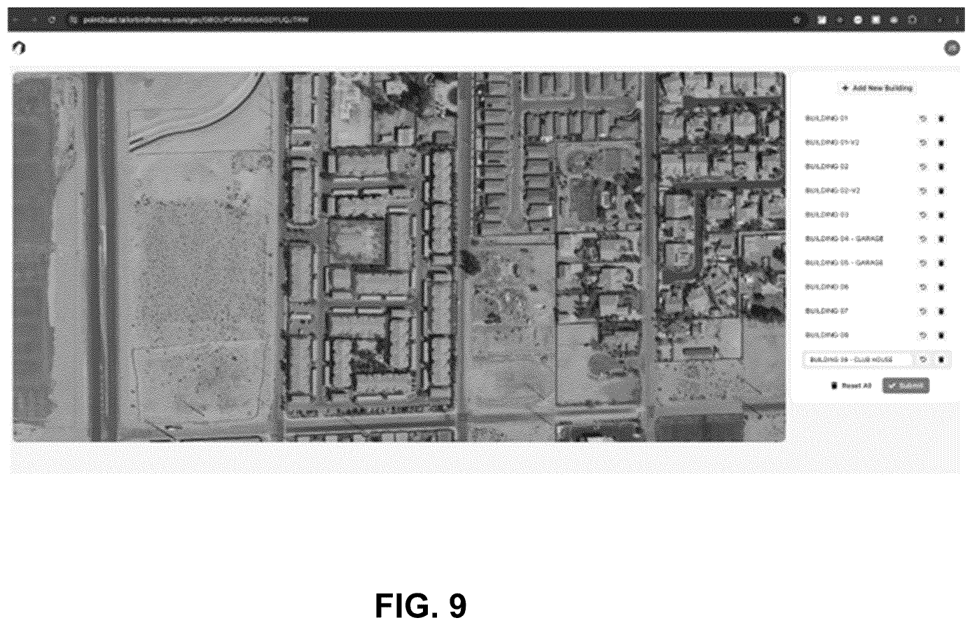

FIG. 9 provides a screenshot of an aerial image where the selected building is highlighted (in green). The cropping of building of interest from an aerial image may be conducted by the system. In certain embodiments, the system may be provided additional information and/or parameters to come up with the automated mask for cropping the building.

In certain preferred embodiments, the system further provides generation of orthomosaic from the alignment data. An orthomosaic is a geometrically corrected image that combines multiple aerial images into a single, seamless mosaic. This orthomosaic provides a detailed and accurate representation of the area of interest, free from distortions caused by the camera angles and terrain variations.

In certain preferred embodiments, the system further provides determination of reconstruction area in the aerial images. The reconstruction area is determined based on the specific area of interest. The boundaries of the region will be determined the area of the reconstructed in 3D.

A mesh model is generated in the defined reconstruction area. The mesh model represents the 3D surface of the area of interest. It is created by triangulating the key points and other features detected in the images, resulting in a detailed and accurate 3D representation of the terrain and structures. The mesh model is then resampled to generate a point cloud. A point cloud is a collection of data points in space, representing the 3D coordinates of the surface

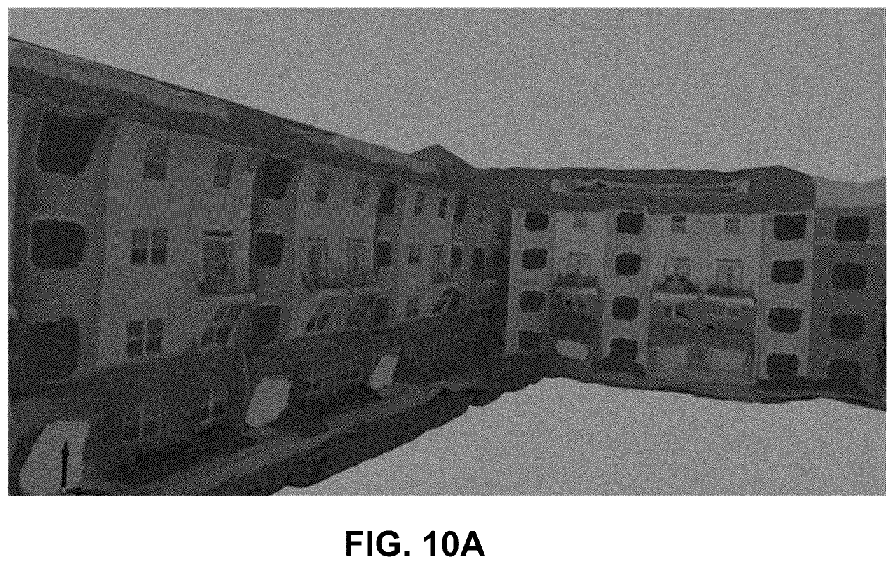

FIGS. 10A and 10B provide a screenshot of a point cloud partial segmentation to detect windows in the cropped aerial image for the building. The exemplary image demonstrates the identification of windows in the said image.

In certain embodiments, an elevation model is generated from the 3D model. This model represents the height of the terrain and structures above a reference surface, such as sea level.

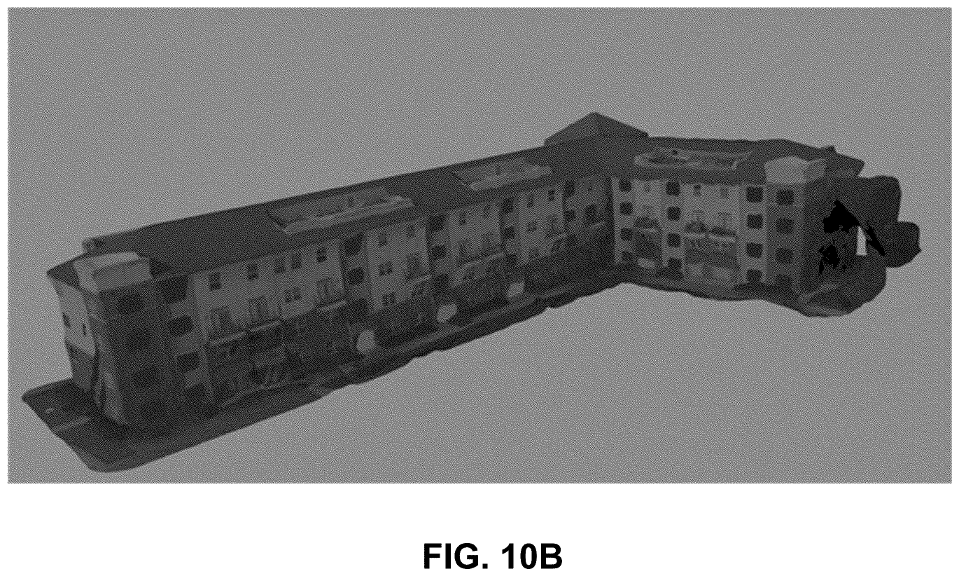

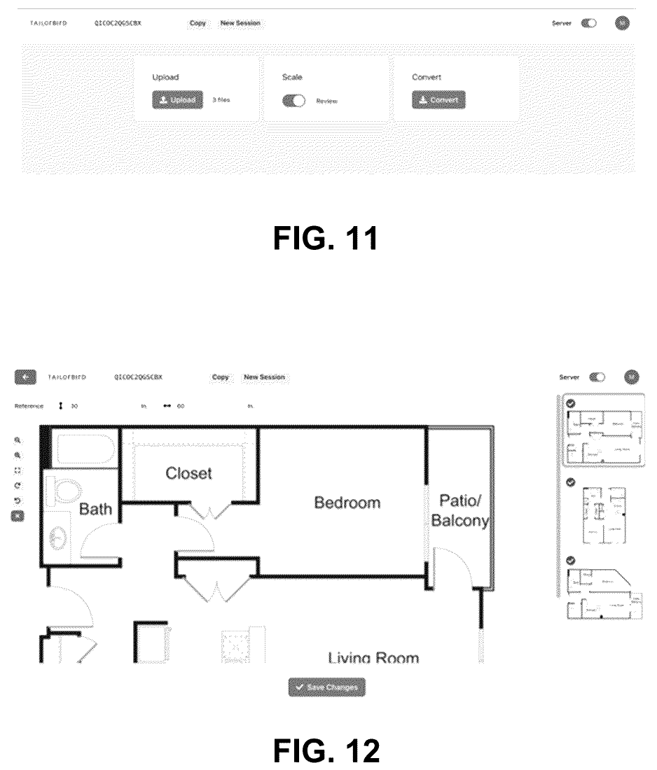

FIG. 11 provides a screenshot for the vector transformation interface. The interface provides the option of uploading the floorplan interface. FIG. 12 provides the interface displaying the various floorplans uploaded in the system.

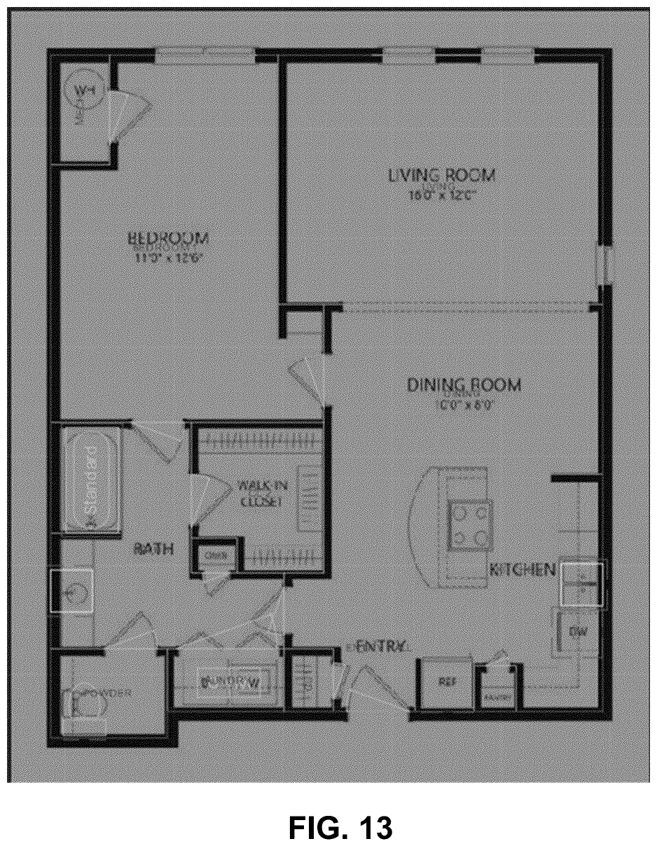

FIG. 13 provides the screenshot of an example of the vectorized output of the generated floorplan overlaid on the input image of the floorplan. In certain embodiments, the 2D vector model is generated by the interior model generation module.

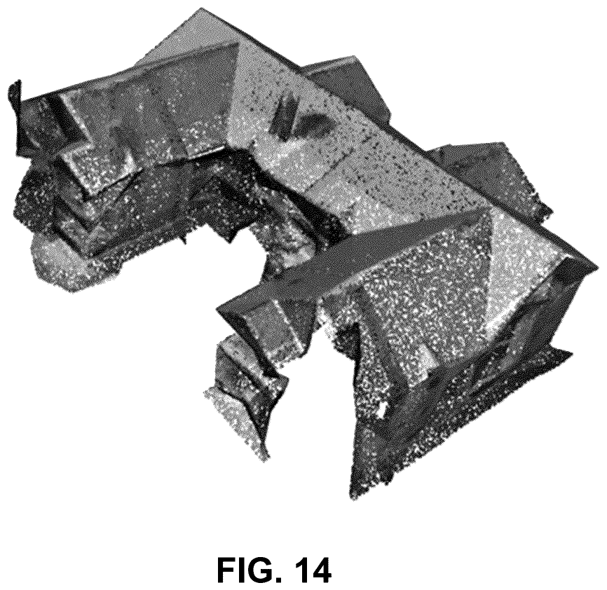

FIG. 14 provides a screenshot of the example of the 3D point cloud of building's exterior generated from the aerial image from the exterior model generation module.

In certain embodiments, based on the elevation data and building footprints, a building shell is generated. The building shell represents the outer surface of the buildings, providing a simplified 3D model of the structures. In certain embodiments, the elevation data and roof boundary detection are relied upon to generate the roof structure of the buildings. The edges and features of the roofs in the elevation model are identified, creating a detailed 3D representation of the roof structures. This step ensures that the buildings are accurately modeled, including their roof shapes and features.

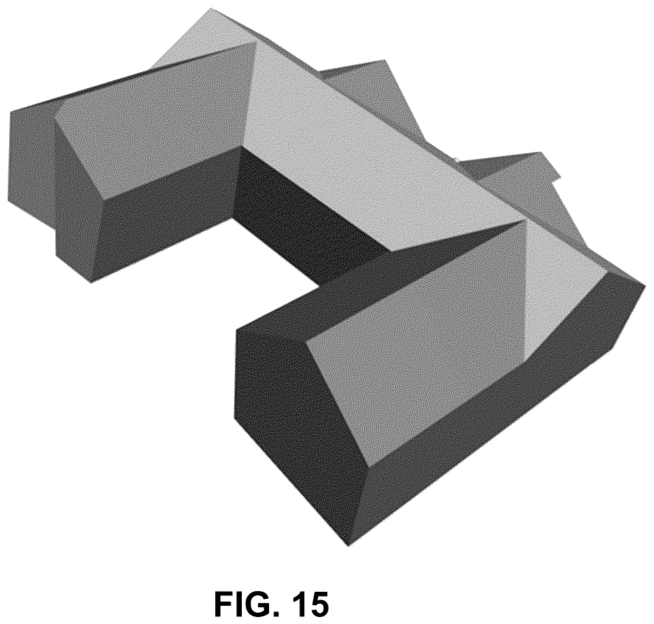

FIG. 15 is a screenshot of the 3D shell model of the roof and the walls of the building generated from the 3D point cloud of the building's exterior.

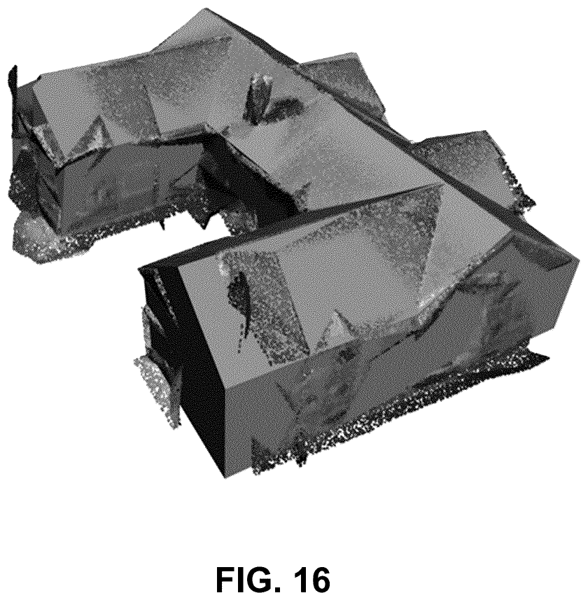

FIG. 16 is a screenshot of the 3D shell overlaid with the 3D point cloud via the exterior model generation module.

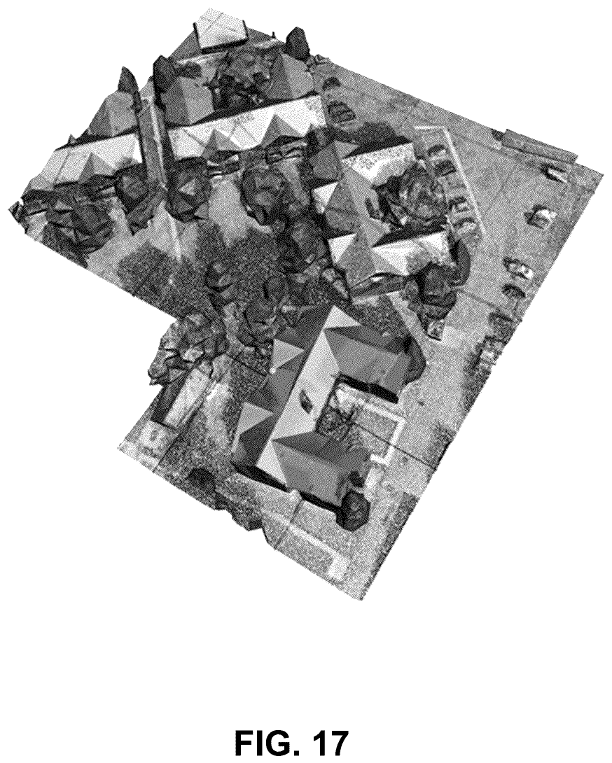

FIG. 17 is a screenshot of the 3D shell (output) overlaid on the uncropped 3D point cloud from the aerial image. The screenshot in FIG. 16 compiles the generated shell of the building with the remaining real estate property.

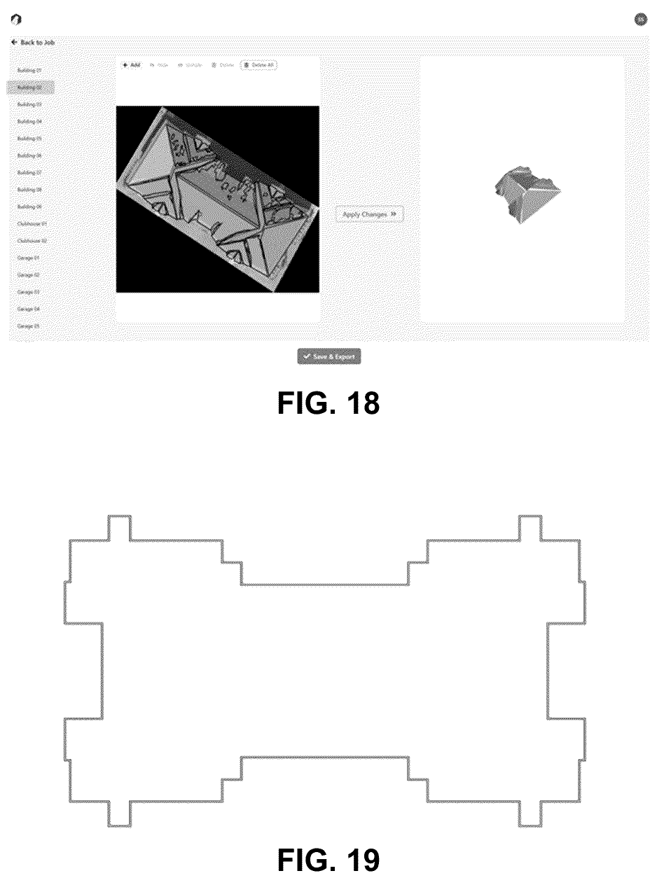

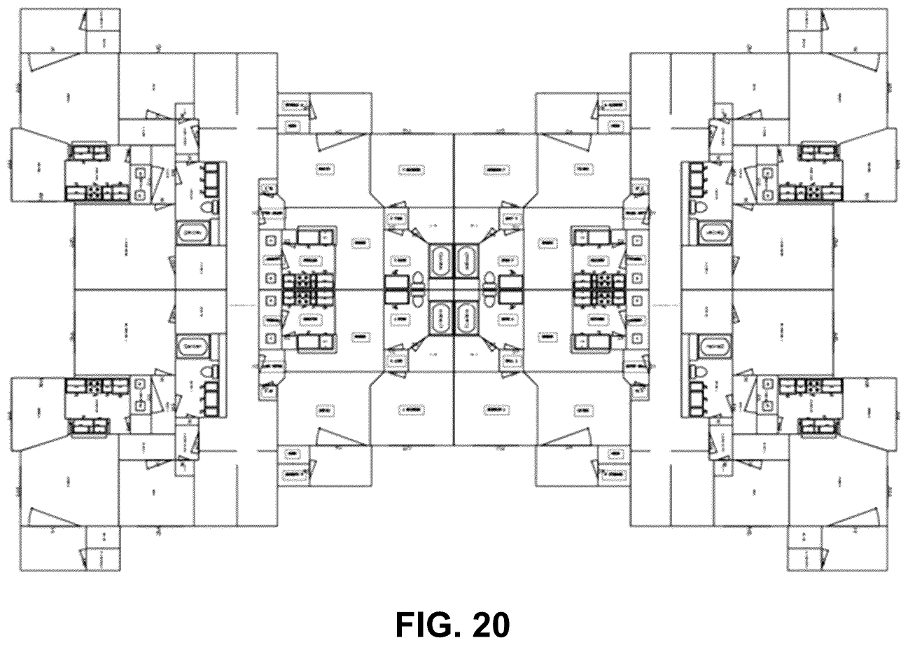

FIG. 18 is a screenshot of the roof creation tool from the generated aerial images. FIG. 19 is an example of a building floor outline extracted from the 3D building shell.

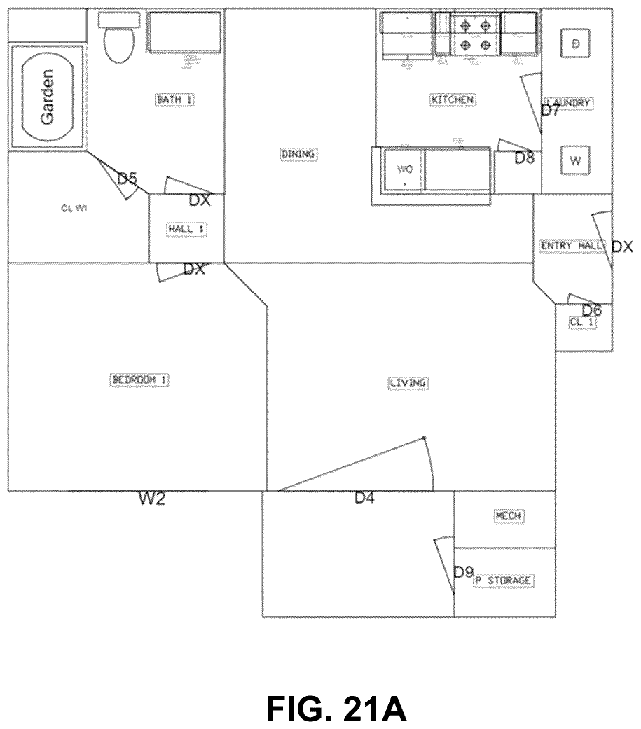

FIG. 20 is an example of final output of merging module for each floor of the building.

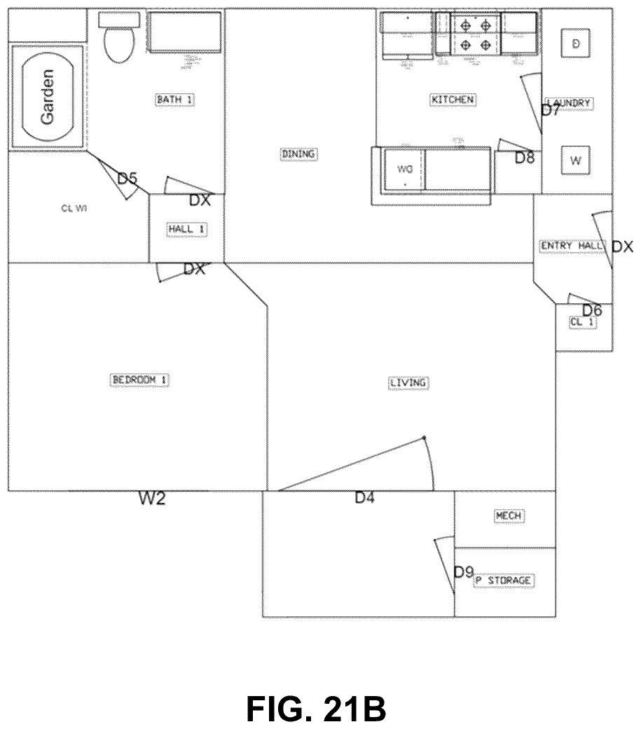

FIGS. 21A and 21B are examples of 2D floorplan vector models of each subunit in the building.

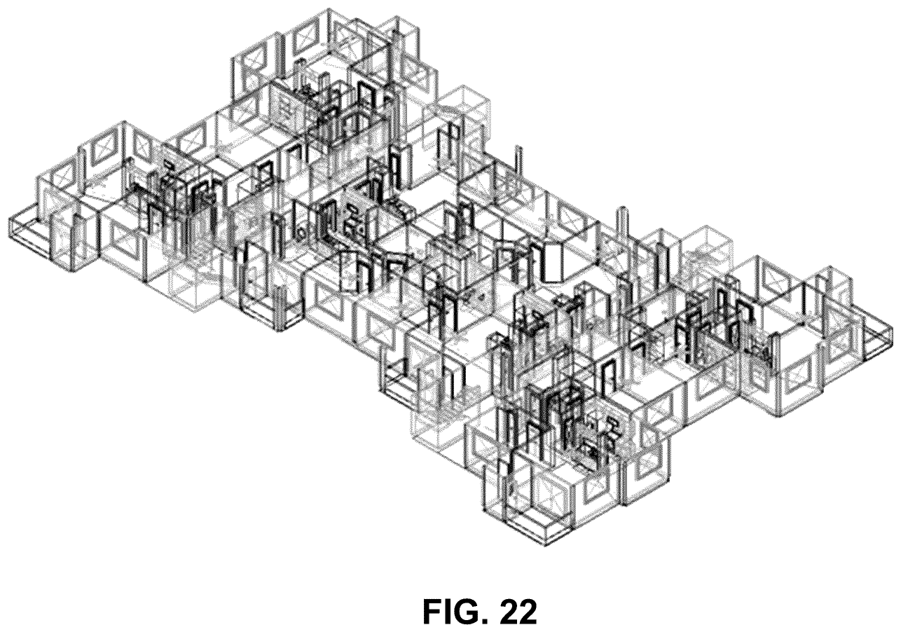

FIG. 22 provides an example of the 3D model of the building generated by the merging module of the system.

The 3D model generated from the system beneficially includes the information regarding the building, including, but not limited to, the floorplan, the dimensions of subunits in the building.

In certain embodiments, semantic segmentation is performed on the source images to classify different elements in the images. This process involves using machine learning or deep learning algorithms to segment the images into different classes. The segmentation results are applied to the point cloud using camera and image correlation. The segmented elements from the 2D images are mapped onto the 3D point cloud, ensuring that each point in the cloud is associated with a specific class. This step enhances the point cloud with semantic information, enabling more detailed analysis and processing.

In certain embodiments, building elements are added to the building shell using the segmented point cloud. Various features such as windows, doors, and other architectural elements are integrated into the 3D model of the buildings. The segmented point cloud provides the necessary information to accurately place and model these elements, resulting in a detailed and realistic representation of the buildings.

The systems of the invention beneficially provide a novel and efficient method to generate 3D models for management of real estate properties or buildings. The system of the invention beneficially combines the data from public databases, processes said data to determine the structure and characteristics of the properties, and generates a 3D model based on this data. Specifically, the methods of the invention do not require the on-site manual collection of the data.

The systems of the invention have application in urban planning and management of real estate properties. The 3D models generated from the system provide accurate representation of the buildings. This enables virtual representative tours and enables more accurate decisions about the building.

The invention further recognizes that the systems provided in the invention are applicable to 3D model generation of any structure. Specifically, the systems of the invention may be utilized for generation of 3D models of multifamily housing, single family housing, condominiums, apartments, and/or townhouses. The systems of the invention may also be utilized for generating 3D models of commercial buildings, such as malls, shopping complexes, multilevel parking lots, hospitals, airports (including various structures in the airport, such as airport terminals, parking ramps, baggage storage buildings, and cargo handling facilities), and/or stadiums. In certain other aspects, the systems of the invention may be utilized to generate accurate 3D models of government buildings, including the municipal complexes, schools, and/or buildings pertaining to the utility services.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A system for generating a three-dimensional (3D) model of a building, the system comprising:
a server configured to communicate and exchange data with one or more computing devices over a network, the server comprising a hardware processor coupled to non-transitory, computer-readable memory containing instructions executable by the processor to cause the server to:
retrieve, via a data retrieval module, data from databases associated with the building, including retrieving at least a first set of data and a second set of data;
generate, via an exterior model generation module, a two-dimensional (2D) building floor outline corresponding to an exterior perimeter of one or more floors the building based, at least in part, on processing the first set of retrieved data and determining, based on the processing, exterior dimensions and/or characteristics building;
generate, via an interior model generation module, a 2D vector model of an interior layout of each floor of the building based, at least in part, on processing the second set of retrieved data and determining, based on the processing, a floor plan layout for each floor of the building; and
compile, via a merging module, the 2D building floor outline and a 2D vector model generated for each floor of the building to thereby generate a 3D model of the building.

2. The system of claim 1, wherein the databases are publicly available databases.

3. The system of claim 2, wherein the retrieving step comprises collecting data from at least three different public databases, wherein the public databases comprise information related to said building.

4. The system of claim 1, wherein the data comprises information associated with geographical, structural, and/or aesthetic details of the building.

5. The system of claim 1, wherein the first set of data comprises aerial images of the building and the exterior model generation module is configured to generate at least one of a 3D point cloud model and a 3D mesh model from the aerial images.

6. The system of claim 5, wherein the exterior model generation module processes the aerial images by running one or more convolutional neural network (CNN) models and/or one or more plane fitting algorithms to generate a 3D shell model from the 3D point cloud model and/or the 3D mesh model.

7. The system of claim 6, wherein the 3D shell model comprises a plurality of exterior features associated with the exterior of the building.

8. The system of claim 7, wherein the plurality of exterior features comprise one or more walls, roofs, and/or other exterior elements associated with the building.

9. The system of claim 7, wherein the 3D shell model comprises one or more different floors of the building.

10. The system of claim 1, wherein the interior model generation module is configured to perform, via a web scraper, web data extraction.

11. The system of claim 10, wherein the web data extraction comprises automatically searching for, and extracting, unit interior data from public websites associated with one or more floorplans and/or images of interior space of the building.

12. The system of claim 11, wherein the server is configured to store the unit interior data, along with relevant metadata associated therewith, in an associated database.

13. The system of claim 12, wherein the interior model module processes the unit interior data by running one or more convolutional neural network (CNN) models for detecting visible interior elements associated with at least one of the one or more floorplans.

14. The system of claim 13, wherein the visible interior elements are associated with walls, doors, windows, and/or other internal fixtures.

15. The system of claim 1, wherein the merging module runs a genetic algorithm to fill in the 2D building floor outline with one or more known 2D vector models of a given floorplan type functioning as a dwelling building unit.

16. The system of claim 15, wherein the merging module is configured to implement an optimization model.

17. The system of claim 16, wherein the merging module is configured to optimize a dwelling building unit by implementing one or more loss functions, wherein the loss functions are selected from the group consisting of:
minimizing empty space in the 2D vector model to account for corridors;
minimizing a number of adjustments each floorplan type will have during optimization; and
maximizing an amount of overlap each floorplan type will have within an outline of a given floorplan of the 2D vector model.

18. The system of claim 17, wherein the optimization step further comprises defining one or more constraints in the optimization model.

19. The system of claim 18, wherein the one or more constraints comprise matching placement of one or more interior elements of the 2D vector model with corresponding one or more exterior elements of the 2D building floor outline.

20. The system of claim 1, further comprising a spatial analysis module configured to process one or more images of interior space of the building to determine dimensions, including heights, of interior elements of the building based on processing of the one or more images.

21. The system of claim 20, wherein the spatial analysis module is configured to adjust the 2D vector model based on the determined dimensions of the interior elements, thereby resulting in generation of the 3D model of the building providing an accurate scale of interior elements.

22. The system of claim 1, wherein the building is selected from the group consisting of: buildings, apartment dwellings, multifamily housing, hotels, retail outlets, malls, student housing, and schools.

23. The system of claim 1, wherein the server is further configured to annotate the 3D model with the details associated with interior elements of the building.

24. The system of claim 23, wherein the details comprise number of furnishings, fixtures, and equipment.

25. The system of claim 24, wherein the furnishings and fixtures are selected from the group consisting of: cabinet box sets, cabinet fronts, number of light switches, light fixtures, bathroom amenities, and ceiling fans.
